(19) United States
(12) Patent Application Publication
(10) Pub. No.: US 2025/0368272 A1
(43) Pub. Date: Dec. 4, 2025

(54) LOWER DASH

(71) Applicant: GF Casting Solutions AG, Schaffhausen (CH)

(72) Inventors: Stephan PHILIPP, Gailingen (DE); Fabian KOHLBRENNER, Höchenschwand (DE); Niclas BENTZEN, Göteborg (SE); Zef VAN DER PUTTEN, Göteborg (SE); Thomas KARLSSON, Göteborg (SE); Mikael APPELGREN, Göteborg (SE)

(21) Appl. No.: 19/218,419

(22) Filed: May 26, 2025

(30) Foreign Application Priority Data
May 28, 2024 (EP) 24 178 455.2

(51) Int. Cl. B62D 25/14; B62D 25/04; B62D 29/00

(52) U.S. Cl. CPC B62D 25/14; B62D 25/04; B62D 29/008

(57) ABSTRACT

A lower dash for a motor vehicle that extends in a y-direction transversely to the direction of travel for the motor vehicle and separates a passenger compartment and a front compartment of the motor vehicle. The lower dash includes a partial bulkhead, an inner partial A-pillar arranged laterally with respect to the patrial bulkhead, and a side member front including a connector, each on the left and right sides in the vehicle direction. The inner partial A-pillar, the partial bulkhead, and the side member front arranged on the left side are designed as a one-piece part-lower dash made of die-cast light metal, and the inner partial A-pillar, the partial bulkhead, and side member front on the right side are designed as a one-piece part-lower dash made of die-cast light metal. The one-piece part-lower dash arranged on the left-hand and right-hand sides are connected to one another via a joining.

### CROSS REFERENCE TO RELATED APPLICATIONS

This application claims benefit to European Patent Application No. EP 24 178 455.2, filed on May 28, 2024, which is hereby incorporated by reference herein.

### FIELD

The invention relates to a lower dash for a motor vehicle, the lower dash extending in a y-direction transversely to the direction of travel for the motor vehicle x, and being configured to separate a passenger compartment and a front compartment of the motor vehicle. The lower dash of the present disclosure includes a partial bulkhead, an inner partial A-pillar arranged laterally with respect to the partial bulkhead, and a side member front including a connector to the sill and longitudinal rail, each on the left and right sides in the vehicle direction.

### BACKGROUND

DE 10 2008 062 007 A1 discloses a bulkhead which is of a multi-part design, namely comprising a lower crossmember, a bulkhead element, and an upper reinforcing member, wherein the lower crossmember is designed as a light-metal die-cast component, and the bulkhead element and also the upper reinforcing member are formed from a light-metal sheet. The elements are connected to one another, e.g. by welding, screwing, adhesive bonding or clinching.

The disadvantage here is the high outlay for connecting the individual parts to one another.

DE 10 2008 062 004 A1 discloses a body structure in which the bulkhead has a flange and is connected to the crossmember, which likewise has a flange. In this case, the bulkhead is formed from a light-metal sheet and is preferably welded or adhesively bonded to the crossmember. Here too, there is the disadvantage of the high expenditure of time in bringing the individual elements together before the structural body part can be installed in the vehicle body.

### SUMMARY

In an embodiment, the present disclosure provides a lower dash for a motor vehicle that extends in a y-direction transversely to the direction of travel for the motor vehicle and separates a passenger compartment and a front compartment of the motor vehicle. The lower dash includes a partial bulkhead, an inner partial A-pillar arranged laterally with respect to the partial bulkhead, and a side member front including a connector, each on the left and right sides in the vehicle direction. The inner partial A-pillar, the partial bulkhead, and the side member front arranged on the left side are designed as a one-piece part-lower dash made of die-cast light metal, and the inner partial A-pillar, the partial bulkhead, and side member front on the right side are designed as a one-piece part-lower dash made of die-cast light metal. The one-piece part-lower dash arranged on the left-hand and right-hand sides are connected to one another via a joining.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a three-dimensional view of the lower dash when viewed from the passenger compartment, in accordance with an embodiment of the present disclosure;

FIG. 2 shows a plan view of the lower dash when viewed from the passenger compartment, in accordance with an embodiment of the present disclosure;

FIG. 3 shows a three-dimensional view of the two part-lower dashes before joining, in accordance with an embodiment of the present disclosure;

FIG. 4 shows a side view of the inner partial A-pillar and the side member front of the lower dash, in accordance with an embodiment of the present disclosure;

FIG. 5 shows a three-dimensional view of the lower dash when viewed from the front compartment, in accordance with an embodiment of the present disclosure; and

FIG. 6 shows a three-dimensional view of the lower dash from the underside, in accordance with an embodiment of the present disclosure.

### DETAILED DESCRIPTION

In an embodiment, the present disclosure provides a lower dash and a method associated therewith which shortens the production time, reduces logistics expenses, and requires as few manual working steps as possible, to increase the economic efficiency of the lower dash, and also so that the lower dash is as light as possible and yet, still has a high degree of stiffness. The stiffness of the lower dash of the present disclosure absorbs, in the event of a center pole crash, the same energy as a steel construction known from the state of the art, but with a significantly lower weight.

In an embodiment of the present disclosure the inner partial A-pillar, the partial bulkhead, and the side member front arranged on the left side are designed as a one-piece part-lower dash made of die-cast light metal, preferably high pressure die-cast, and the inner partial A-pillar, the partial bulkhead and side member front on the right side are designed as a one-piece part-lower dash made of die-cast light metal, wherein the part-lower dash arranged on the left-hand and right-hand sides are connected to one another via a joining.

The lower dash for a motor vehicle of the present disclosure is configured to extend in y-direction transversely to the direction of travel for the motor vehicle x, and is configured to separate a passenger compartment and a front compartment of the motor vehicle. The lower dash comprises, a partial bulkhead, an inner partial A-pillar arranged laterally with respect to the partial bulkhead, and a side member front including a connector to the sill and longitudinal rail, each on the left and right sides in the vehicle direction. It is advantageous if the partial A-pillar arranged laterally to the partial bulkhead is arranged on the side facing the outside of the vehicle in the y-direction. The inner partial A-pillar, the partial bulkhead, and the side member front arranged on the left side are designed as a one-piece part-lower dash made of die-cast light metal, and the inner partial A-pillar, the partial bulkhead, and side member front on the right side are designed as a one-piece part-lower dash made of die-cast light metal. In other words, the lower dash consists of two separately manufactured die-cast parts, one of which forms the right-hand side and the other the left-hand side. Each of the two part-lower dashes contains the components listed, which are integrally molded on, respectively, or which are molded in one piece. The part-lower dash arranged on the left-hand and right-hand sides are connected to one another via a joining technology. It is advantageous if the part-lower dashes can be moved towards each other along the joining. This allows a certain tolerance compensation to take place and the lower dash is easier to install in the chassis. In addition the part-lower dashes can be manufactured more easily and shipped in a more space-saving manner before assembly.

In an embodiment of the present disclosure, between the two partial bulkheads is a joining region arranged. It is advantageous, if the joining region extends along the edge of the partial bulkheads that faces the center of the vehicle.

In an embodiment of the present disclosure, the joining is built by a mutual overlap of the two partial bulkheads. It is advantageous if there is a strip at the edge of the partial bulkhead that extends along the partial bulkhead and serves as a joining strip. The two joining strips then lie on top of each other for joining. In an embodiment the mutual overlap can also be achieved by lugs that are arranged on at least one partial bulkhead and overlap the other one. This overlap enables tolerance compensation via the joining. In this way, the width of the lower dash that extends along the y-direction can be precisely adjusted. The overlaps are preferably screwed together, although another joining technique is also possible.

As previously mentioned, it is advantageous if the joining formed by screwing of the two partial bulkheads together. Of course, joining methods such as gluing, welding, riveting or others are also conceivable.

In an embodiment, the joining runs in the middle of the lower dash in respect to the y-direction, which ensures symmetrical loading and good accessibility to the joining region.

In an embodiment of the present disclosure, the joining runs offset to the middle of the lower dash in respect to the y-direction. As the load on the lower dahs is highest in the middle, it is advantageous if the joining is not located in the middle but offset to it, where the load is lower.

It is advantageous if the part-lower dash is of a thin-walled design, the component wall being is between 1 and 8 mm, preferably between 2 and 5 mm. In an embodiment, the component walls have different thicknesses according to their positioning on the part-lower dash. Due to the different thicknesses of the component walls, the flow behavior during the high pressure die-casting filling process in the part-lower dash is optimized or a filling optimization is achieved. On the one hand, the individual component walls can have different thicknesses according to their arrangement, on the other hand, a component wall itself can also have different thicknesses, i.e. it can taper or widen in order to achieve filling optimization as mentioned above.

In an embodiment of the present disclosure, connecting elements for connecting a battery housing are arranged on the partial bulkheads. In an embodiment, corresponding connection elements such as screw-on points are arranged in the light metal die-cast component to attach a battery housing to the lower dash by joining.

It is advantageous if connecting elements for connecting a chassis subframe are arranged on the partial bulkheads. In an embodiment of the present disclosure, corresponding connection elements such as screw-on points are arranged in the die-cast light metal component to attach a chassis subframe to the lower dash by joining. Of course, other and additional connection points can also be integrated into the lower dash respectively the partial bulkhead, depending on the vehicle type.

In an embodiment, the partial bulkhead has a ribbing for reinforcement. In an embodiment of the present disclosure, the ribbing is arranged on one sides of the partial bulkhead, i.e. in the direction of the passenger compartment or in the direction of the front compartment. In an embodiment, the ribs extend at regular or irregular intervals across the entire width of the partial bulkhead respectively in the y-direction.

It is advantageous if, the side member front has a ribbing for reinforcement. In an embodiment of the present disclosure, the ribbing on the side member front is directed outwards and there is no ribbing towards the center of the vehicle.

In an embodiment, the lower dash is made of an Al- or Mg-alloy.

In an embodiment, the present disclosure provides that two one-piece part-lower dashes are produced by die casting and joined together to the lower dash. By producing the part-lower dashes according to the present disclosure by die casting and then joining the two parts together, a complex, thin-walled and yet stable shape is produced.

It has been shown to be advantageous if the lower dash according to the present disclosure is subjected to a heat treatment after casting and joining. This increases the desired properties, such as the elongation of the material of the lower dash. Heat treatment can be carried out in full or only partially.

All possible embodiments of the present disclosure can be freely combined with one another and the method features also apply to the device and vice versa.

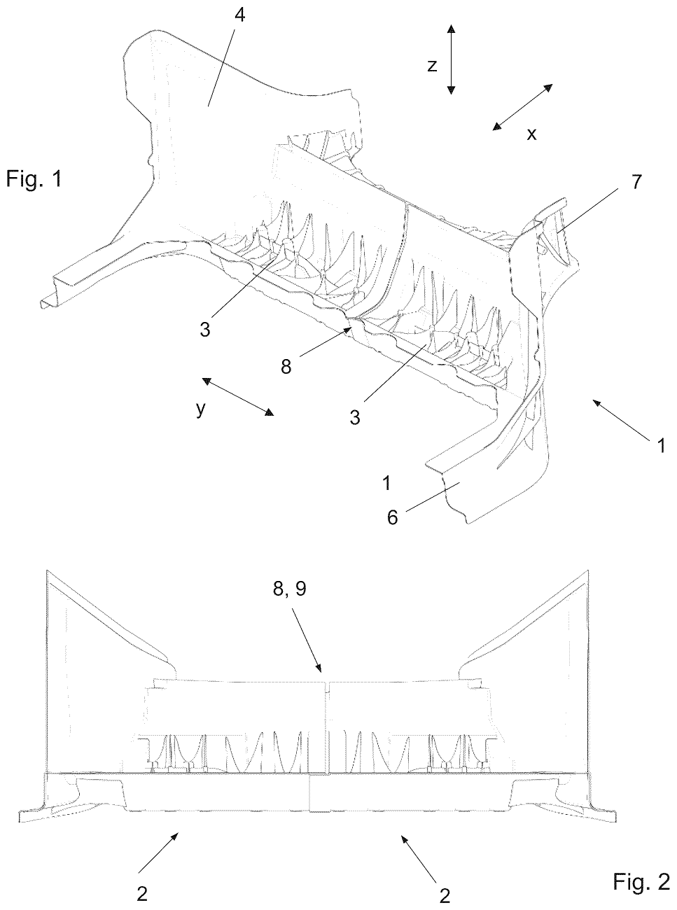

FIG. 1 shows a three-dimensional view of the lower dash 1 for a motor vehicle, in accordance with an embodiment of the present disclosure. The lower dash 1 is configured to extend in a y-direction transversely to the direction of travel for the motor vehicle x. The lower dash 1 is configured to separate a passenger compartment and a front compartment of the motor vehicle. The lower dash 1 of the present disclosure comprises, a partial bulkhead 3, an inner partial A-pillar 4 arranged laterally with respect to the partial bulkhead 3, and a side member front 5. The side member front 5 includes a connector to the sill 6 and to the longitudinal rail 7, as is depicted FIG. 4. The connectors, in an embodiment, are designed as a C-shape so that they can accommodate the longitudinal rail as well as the sill and are joined with them. The overlying partial A-pillar 4 is also depicted in FIG. 4.

The partial bulkhead 3, the inner partial A-pillar 4 arranged laterally with respect to the patrial bulkhead 3, and the side member front 5 are arranged on the lower dash 1 each on the left and right sides in the vehicle direction x.

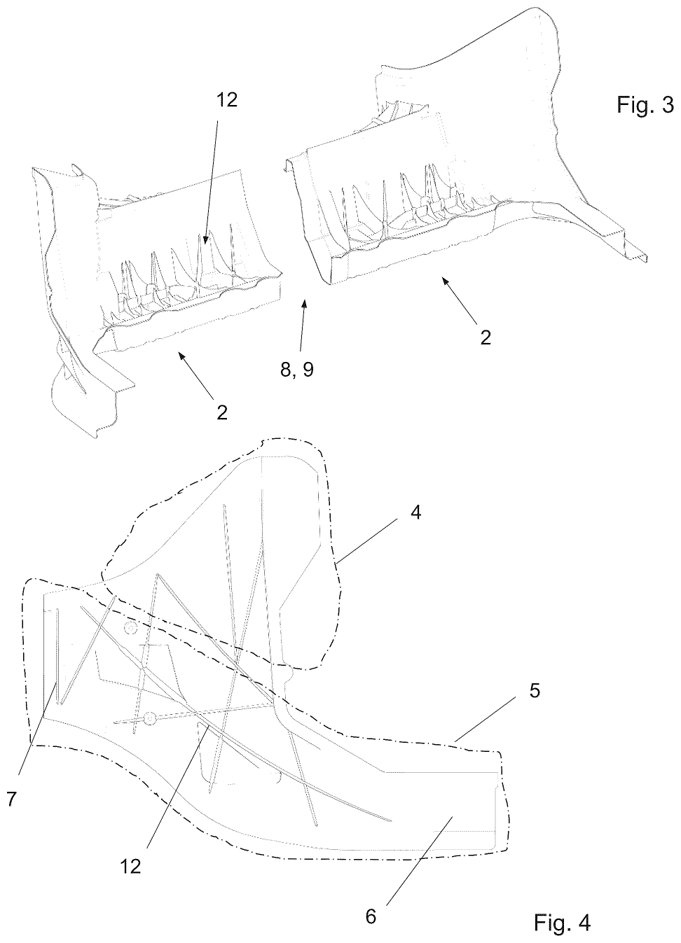

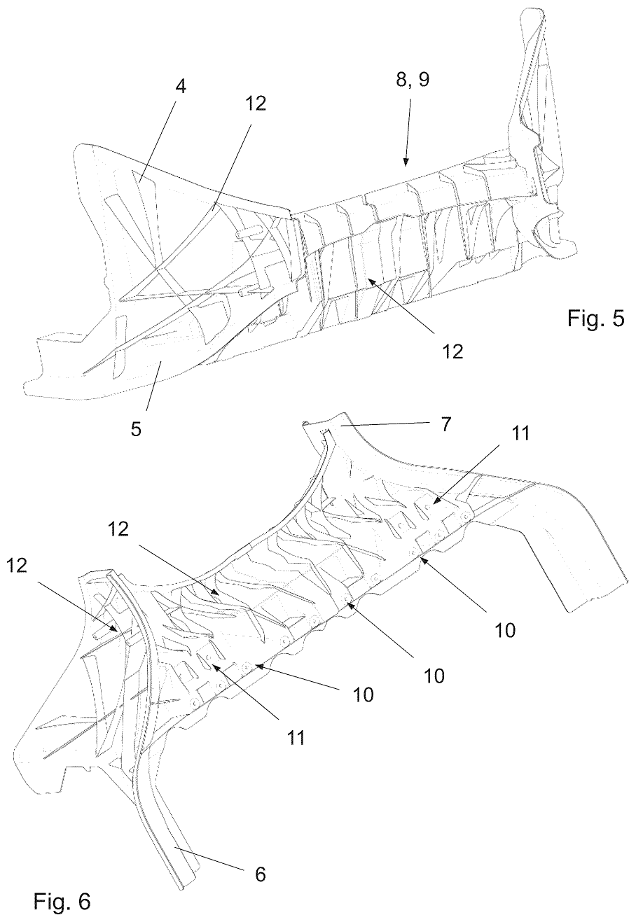

The inner partial A-pillar 4, the partial bulkhead 3, and the side member front 5 arranged each on the left and right side, are designed as a one-piece part-lower dash 2 made of die-cast light metal. This means that the part-lower dash 2 is designed as a one-piece die-cast part to which the components inner partial A-pillar 4, the partial bulkhead 3, and the side member front 5 are integrally molded, i.e. they belong to a complete part-lower dash 2. FIG. 3 clearly shows that the two the part-lower dashes 2 are manufactured as two separately formed die-cast parts.

The two part-lower dashes 2 arranged on the left-hand and right-hand sides are connected to one another via a joining. It is advantageous if the joining area 8 is formed by a mutual overlap 9 of the partial bulkheads 3. In an embodiment of the present disclosure, at least one partial bulkhead 3 along the side that projects into the center of the lower dash 1 respectively to the joining has a strip or lugs for joining that overlap 9 the other partial bulkhead 3 on the part-lower dash 2. It is advantageous if the joining is screwed together along the mutual overlap 9. FIG. 3 shows that the joining 8 runs through the middle of the lower dash 1. This ensures good access for joining and guarantees a symmetrical stress distribution.

The ribbing 12 on the partial bulkhead 3, in an embodiment, extends over its entire width or over the width in the y-direction. The ribbing 12 is, in an embodiment, arranged on the side facing the front compartment as well as on the side facing the passenger compartment. The ribbing 12 can be carried out at regular or irregular intervals.

The side member front 5 also has a ribbing 12 for stiffening. The ribbing 12 is, in an embodiment, arranged on the outside of the side member front 12 and the side facing the center, in embodiments, has no ribbing. Of course, the course of the ribbing must be adapted to the vehicle to be developed in each case.

The connection elements 10, 11 for the battery housing and the chassis subframe can be seen on the underside. These are integrally molded onto the two part-lower dashes 2, which means that an additional work step can be avoided by joining a connecting element. Of course, further connecting elements can be molded directly onto the part-lower dashes 2 if the design of the vehicle permits this.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMBERS

1 Lower dash
2 part-lower dash, right and left
3 partial bulkhead
4 inner partial A-pillar
5 side member front
6 connector to the sill
7 connector to longitudinal rail
8 joining region
9 overlap, strip
10 connecting elements for connecting a battery housing
11 connecting elements for connecting a chassis subframe
12 ripping
x x-direction
y y-direction
z z-direction

1. A lower dash for a motor vehicle, the lower dash extending in a y-direction transversely to a direction of travel for the motor vehicle and being configured to separate a passenger compartment and a front compartment of the motor vehicle, wherein the lower dash comprises:
a partial bulkhead;
an inner partial A-pillar arranged laterally with respect to the patrial bulkhead; and
a side member front including a connector to a sill and longitudinal rail, each of the partial bulkhead, the inner partial A-pillar, and the side member front being on left and right sides in the vehicle direction, wherein, the inner partial A-pillar, the partial bulkhead and the side member front arranged on the left side are designed as a one-piece part-lower dash made of die-cast light metal, wherein the inner partial A-pillar, the partial bulkhead and the side member front on the right side are designed as a one-piece part-lower dash made of die-cast light metal, and wherein the one-piece part-lower dash arranged on the left-hand and right-hand sides are connected to one another via a joining.

2. The lower dash according to claim 1, wherein a joining region is arranged between the two partial bulkheads.

3. The lower dash according to claim 2, wherein the joining region is built by a mutual overlap of the two partial bulkheads.

4. The lower dash according to claim 2, wherein the joining is formed by screwing together the two partial bulkheads.

5. The lower dash according to claim 3, wherein the joining is formed by screwing the mutual overlap of the two partial bulkheads together.

6. The lower dash according to claim 1, wherein, the joining runs in a middle of the lower dash in respect to the y-direction.

7. The lower dash according to claim 1, wherein, the joining runs offset to a middle of the lower dash in respect to the y-direction.

8. The lower dash according to claim 1, wherein, the one-piece part-lower dash is of a thin-walled design with a component wall being between 1 and 8 mm.

9. The lower dash according to claim 1, wherein, connecting elements for connecting a battery housing are arranged on the partial bulkheads.

10. The lower dash according to claim 1, wherein, connecting elements for connecting a chassis subframe are arranged on the partial bulkheads.

11. The lower dash according to claim 1, wherein, the partial bulkhead has a ribbing for reinforcement.

12. The lower dash according to claim 1, wherein, the side member front has a ribbing for reinforcement.

13. The lower dash according to claim 1, wherein the lower dash is made of an Aluminum (Al-) or Magnesium (Mg-) alloy.

14. A method for producing the lower dash according to claim 1, wherein two one-piece part-lower dashes, a left and a right one, are produced by high pressure die casting and joined together to the lower dash.
